(19) United States
(12) Patent Application Publication
(10) Pub. No.: US 2009/0195935 A1
(43) Pub. Date: Aug. 6, 2009

(54) SUSPENSION INTERCONNECT AND HEAD GIMBAL ASSEMBLY INCLUDING THE SAME

(75) Inventor: Ho-joong CHOI, Daejeon (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/179,786

(22) Filed: Jul. 25, 2008

(30) Foreign Application Priority Data
Feb. 1, 2008 (KR) 2008-10738

(51) Int. Cl. G11B 5/48

(52) U.S. Cl. 360/245.4; 360/245.8

(57) ABSTRACT

A suspension interconnect of a head gimbal assembly (HGA) includes a ground layer; a base layer formed of a dielectric material and disposed on the ground layer; a pair of read traces and a pair of write traces which are formed of a conductive material, disposed on the base layer to extend so as not to short each other; and a cover layer which are formed of a dielectric material, disposed on the base layer and the traces and are to seal the traces, wherein the cover layer includes a read cover layer which is to seal the read traces, and a write cover layer which is separated from the read cover layer and to seal the write traces.

### CROSS-REFERENCE TO RELATED APPLICATIONS

This application claims priority under 35 U.S.C. §119(a) from Korean Patent Application No. 10-2008-0010738, filed on Feb. 1, 2008, in the Korean Intellectual Property Office, the disclosure of which is incorporated herein in its entirety by reference.

### BACKGROUND OF THE INVENTION

1. Field of the Invention

The present general inventive concept relates to a hard disk drive (HDD), and more particularly, to a suspension interconnect functioning as a medium to exchange an electrical signal between a head slider of a HDD and a main circuit board, and a head gimbal assembly (HGA) including the suspension interconnect.

2. Description of the Related Art

A hard disc drive (HDD) is an example of an auxiliary memory device used by computers, MP3 players, or mobile phones, and an apparatus that reads data stored in a disc, which is a data storage medium, or records new data on the disc using a head slider which is a medium for reading and writing data. The head slider maintains a floating state by being suspended by a predetermined gap above the disc during an operation of the HDD, and a magnetic head formed in the head slider reads data stored in the disc so as to reproduce the data or writes data so as to record new data onto the disc.

The data stored in the disc and read by the magnetic head is converted into an electrical signal to be transmitted from the head slider to a main circuit board of an HDD via a flexible printed circuit (FPC). Alternatively, an electrical signal corresponding to the data that is to be recorded onto the disc is transmitted from the main circuit board to the head slider via the FPC. Hereinafter, for convenience of description, the former electrical signal is referred to as a ‘read signal’, and the latter electrical signal is referred to as a ‘write signal’.

The read and write signals are transferred between the head slider and the FPC via a suspension interconnect. FIG. 1 is a cross-sectional view illustrating a conventional suspension interconnect 10.

Referring to FIG. 1, the suspension interconnect 10 includes a ground layer 11, a base layer 13 formed of a dielectric material and disposed on the ground layer 11, a plurality of traces 21a, 21b, 23a, 23b, 25 and 26 formed of a conductive material and disposed on the base layer 13 and a cover layer 15 which is formed of a dielectric material and is for sealing the traces 21a, 21b, 23a, 23b, 25 and 26. The traces 21a, 21b, 23a, 23b, 25 and 26 include a pair of read traces 21a and 21b for transferring a read signal, a pair of write traces 23a and 23b for transferring a write signal, a ground trace 25 connected to the ground layer 11 that is at a ground potential and a flying on demand (FOD) trace 26 for transmitting a driving signal to an FOD element for finely adjusting the flying height of a head slider.

Recently, HDDs have become miniaturized and have increased in capacity. Accordingly, an element for reproducing data stored in a disc, for example, a magnetroresistance (MR) sensor of a magnetic head has improved sensitivity to detect a minute electrical signal. However, the MR sensor is more likely to be damaged due to abnormal disturbances, thereby deteriorating performance of the MR sensor. In addition, a signal having a higher frequency band is used as the write signal, and a rising time of the signal is shortened, compared with the case of the prior art. Thus, because of cross-talk between the read and write signals, a data reproducing element of the magnetic head is more likely to be damaged, thereby deteriorating the performance of the data reproducing element. In addition, the data reproducing element can be damaged because of cross-talk between the read signal and a signal (hereinafter, referred to as a ground signal) of the ground trace 25, or cross-talk between the read signal and a signal of the FOD trace 26 (hereinafter, referred to as an FOD signal).

### SUMMARY OF THE INVENTION

The present general inventive concept provides a suspension interconnect to prevent noise in a read signal due to cross-talk and a head gimbal assembly (HGA) including the suspension interconnect.

The present general inventive concept also provides a suspension interconnect to prevent damage or deterioration of a magnetic head due to cross-talk and an HGA including the suspension interconnect.

Additional aspects and utilities of the present general inventive concept will be set forth in part in the description which follows and, in part, will be obvious from the description, or may be learned by practice of the general inventive concept.

The foregoing and/or other aspects and utilities of the general inventive concept may be achieved by providing a suspension interconnect usable with a hard disk drive (HDD), the suspension interconnect including a ground layer, a base layer formed of a dielectric material and disposed on the ground layer, a pair of read traces and a pair of write traces which are formed of a dielectric material and disposed on the base layer extend so as not to short each other, and a cover layer which is formed of a dielectric material, is disposed on the base layer and the traces and is to seal the traces, wherein the cover layer includes a read cover layer to seal the read traces, and a write cover layer which is separated from the read cover layer and is to seal the write traces.

The suspension interconnect may further include at least one additional trace formed of a conductive material between the read traces and the write traces on the base layer, wherein the read cover layer and the write cover layer may be separated from each other, and the cover layer may further include at least one additional cover layer to seal the additional trace.

The suspension interconnect may further include an additional trace formed of a conductive material between the read traces and the write traces on the base layer, wherein the write cover layer may extend so as to seal the write traces and the additional trace.

The additional trace may include at least one selected from a ground trace that is at a ground potential, a flying on demand (FOD) trace to transmit a driving signal to an element to finely adjust a flying height of a head slider of a hard disk drive (HDD), and a dual servo actuator (DSA) trace to transmit a driving signal to an element to finely adjust track following of the head slider.

The ground layer may be formed of a metal.

The dielectric material used to form the base layer and the cover layer may be polyimide.

The foregoing and/or other aspects and utilities of the general inventive concept may also be achieved by providing a suspension interconnect usable with a hard disk drive (HDD), the suspension interconnect including a base layer formed of a dielectric material, and having a first set of read traces disposed thereon and a second set of other traces formed of a conductive material, and a read cover layer formed of a dielectric material, and to seal the read traces from the second set of other traces.

The suspension interconnect may also include one or more cover layers to seal the second set of other traces, wherein the one or more cover layers is not the read cover layer.

The second set of other traces may include at least write traces which are formed of a conductive material and disposed on the base layer.

The second set of other traces may further include at least one of a ground trace that is at a ground potential, a flying on demand (FOD) trace to transmit a driving signal to an element to adjust a flying height of a head slider of the HDD, and a dual servo actuator (DSA) trace to transmit a driving signal to an element to adjust track following of the head slider.

The foregoing and/or other aspects and utilities of the general inventive concept may also be achieved by providing a suspension interconnect usable with a hard disk drive, the suspension interconnect including a base layer, a first trace formed on a first portion of the base layer, a second trace formed on a second portion of the base layer, a first cover layer formed on the first trace, and a second cover layer formed on the second trace and spaced apart from the first cover layer by a distance with respect to the base layer.

The first cover layer and the second cover layer may be isolated from each other.

The first cover layer may have a first thickness, the second cover layer may have a second thickness, and the distance may be longer than a sum of the first thickness and the second thickness.

The first trace may include a plurality of sub-traces, and the first cover layer may be formed on the plurality of sub-traces.

The first cover layer and the second cover layer may be physically separated from each other.

### BRIEF DESCRIPTION OF THE DRAWINGS

The above and other features and utilities of the present general inventive concept will become more apparent by describing in detail exemplary embodiments thereof with reference to the attached drawings in which:

FIG. 1 is a cross-sectional view illustrating a conventional suspension interconnect;

FIG. 2 is a plan view illustrating a hard disc drive (HDD) according to an embodiment of the present general inventive concept;

FIG. 3 is a bottom view illustrating a head gimbal assembly (HGA) according to an embodiment of the present general inventive concept;

FIG. 4 is a cross-sectional view illustrating a suspension interconnect taken along a line A-A of FIG. 3;

FIG. 5 is a cross-sectional view illustrating a suspension interconnect according to another embodiment of the present general inventive concept; and

FIG. 6 is a cross-sectional view illustrating a suspension interconnect according to another embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

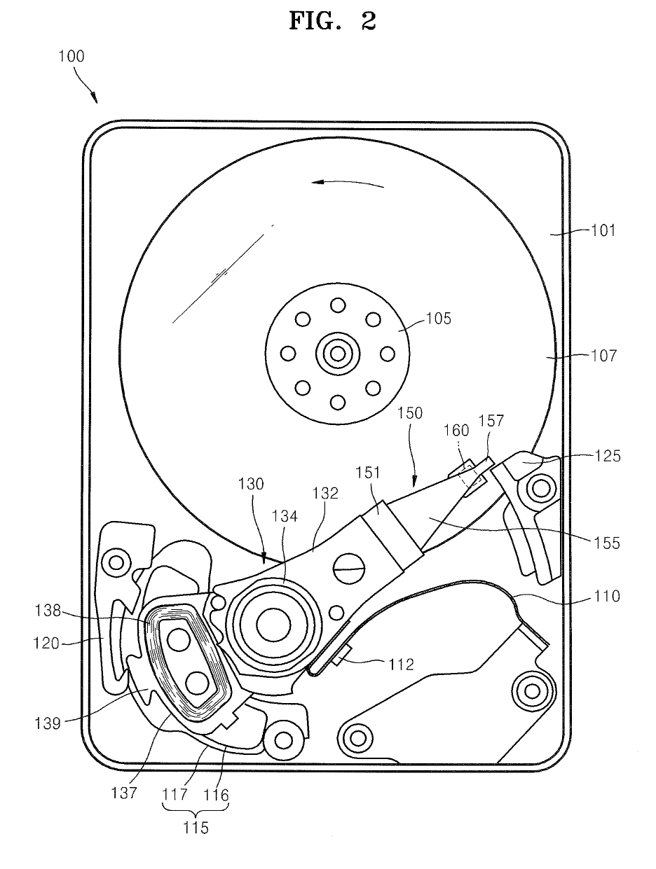

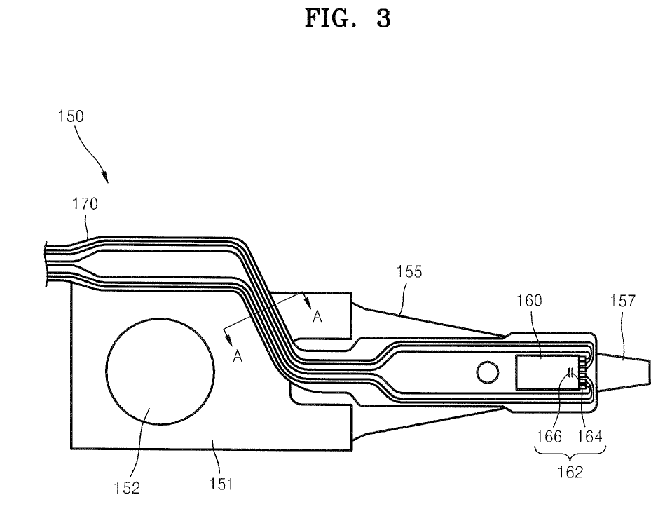

FIG. 2 is a plan view of a hard disc drive (HDD) 100 according to an embodiment of the present general inventive concept. FIG. 3 is a bottom view of a head gimbal assembly (HGA) 150 according to an embodiment of the present general inventive concept. Hereinafter, the HDD will be described, and then a suspension interconnect and the HGA including the suspension interconnect will be described with reference to FIG. 2.

Referring to FIG. 2, the HDD 100 includes a spindle motor 105, a disc 107 which is a data medium, a head stack assembly (HSA) 130 and a voice coil motor (VCM) block 115 in a housing including a base member 101 and a cover member (not illustrated) coupled to the base member 101. The spindle motor 105 rotates the disc 107 at a high speed, and is fixed on the base member 101. The disc 107 is coupled to the spindle motor 105 so as to be rotated at a high speed in a direction indicated by the arrow illustrated in FIG. 2. Due to the high speed rotation of the disc 10, an air flow in a same direction as the rotation of the disc 107 is induced on a surface of the disc 107.

The HSA 130 includes a head slider 160 on which a magnetic head 162 (see FIG. 3) to perform a write or read operation on the disc 107 is formed. The head slider 160 writes data onto the disc 107 or reads data recorded on the disc 107 by being moved to a predetermined track on the disc 107. The HSA 130 includes a pivot bearing 134, a swing arm 132 rotating around the pivot bearing 134 as a center of rotation, a connection plate 151 is swaged to a fore-end of the swing arm 132, a suspension 155 coupled to the connection plate 151 and the head slider 160 mounted on a fore-end of the suspension 155. Also, the HSA 130 includes an overmold 137 that is coupled to the swing arm 132 and includes a voice coil 138.

An air flow induced due to the high speed rotation of the disc 107 passes through a gap between the surface of the disc 107 and the head slider 160, generating a lifting force which can lift the head slider 160. Thus, the head slider 160 maintains a floating state at a height where the lifting force and an elastic force applied to the suspension 155 towards the disc 107 are at equilibrium. In this floating state, the magnetic head 162 (see FIG. 3) formed on the head slider 160 writes data on the disc 107 or reproduces data recorded on the disc 107. In particular, referring to FIGS. 2 and 3, the magnetic head 162 includes a writer 164 to record data on the disc 107 and a reader 166 to reproduce data recorded on the disc 107. The writer 164 may include, for example, a magnetic pole (not illustrated) and a coil (not illustrated). The reader 166 may include, for example, a magnetroresistance (MR) sensor.

When the HDD 100 stops operating, the head slider 160 deviates from the disc 107 to be parked on a ramp 125 disposed away from the disc 107. The suspension 155 includes an end-tap 157 at an end of the suspension 155. The end-tap 157 comes in contact with the ramp 125 so as to slide onto the ramp 125, and then the HSA 130 and the head slider 160 are parked on the ramp 125.

The HDD 100 includes a latch 120. When the HSA 130 is parked on the ramp 125, the latch 120 is engaged with a hook 139 formed on the overmold 137 so as to lock the HSA 130. When the HDD 100 stops operating, damage to the head slider 160 and the disc 107 due to a disturbance can be prevented by virtue of the ramp 125 and the latch 120.

The VCM block 115 is fixed on the base member 101, and the voice coil 138 of the overmold 137 is inserted into the VCM block 115 to allow the voice coil 138 to move freely. The VCM block 115 includes magnets 116 disposed on upper and lower portions of the voice coil 138, and a yoke 117 supporting the magnets 116. The voice coil 138, the magnets 116 and the yoke 117 constitute a voice coil motor providing a driving force to rotate the HSA 130. The rotation of the HSA 130 is controlled by a servo control system.

The HSA 130 is electrically connected to a flexible printed circuit (FPC) 110. The FPC 110 is electrically connected to a main circuit board (not illustrated) which is disposed below the base member 101 and controls the driving of the HSA 130 and the spindle motor 105. The FPC 110 functions as a medium to exchange electrical signals between the HSA 130 and the main circuit board. A reference number 112 denotes a pre-amplifier to amplify electrical signals.

Referring to FIG. 3, a suspension interconnect 170 is a medium to exchange electrical signals between the head slider 160 at an end of the HSA 130 (see FIG. 2) and the FPC 110 (see FIG. 2). One end of the suspension interconnect 170 extends to the head slider 160 so as to be electrically connected thereto. An other end of the suspension interconnect 170 extends to a terminal (not illustrated) of the FPC 110 to be electrically connected to the FPC 110. A head gimbal assembly (HGA) 150 includes the connection plate 151, the suspension 155, the head slider 160 and the suspension interconnect 170. A swaging hole 152 is formed in the connection plate 151 and is to swag the HGA 150 to an end of the swing arm 132.

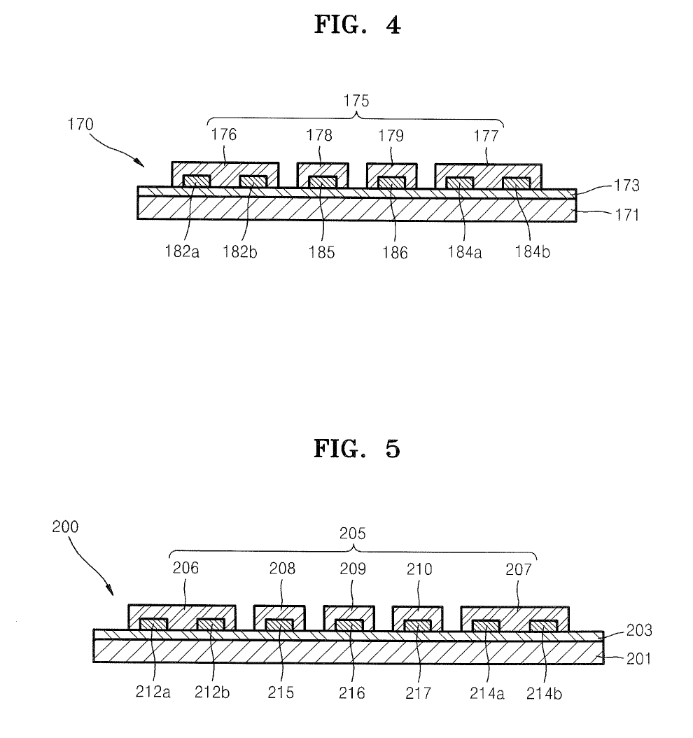

FIG. 4 is a cross-sectional view illustrating the suspension interconnect 170 taken along a line A-A of FIG. 3.

Referring to FIG. 4, the suspension interconnect 170 includes a ground layer 171, a base layer 173 formed of a dielectric material on the ground layer 171, traces 182a, 182b, 184a, 184b, 185 and 186 formed of a conductive material such as copper (Cu) and extending so as not to short each other and a cover layer 175 which is formed on the base layer 173 and the traces 182a, 182b, 184a, 184b, 185 and 186 and is to seal the traces 182a, 182b, 184a, 184b, 185 and 186. The ground layer 171 may be formed of metal such as stainless steel or Cu. The base layer 173 and the cover layer 175 may be formed of polyimide by using a method such as film laminating, spin coating or vapor deposition.

The traces 182a, 182b, 184a, 184b, 185 and 186 include a pair of read traces 182a and 182b to transmit a read signal from the reader 166 (see FIG. 3) of the magnetic head 162 (see FIG. 3) to the pre-amplifier 112 (see FIG. 2), a pair of write traces 184a and 184b to transmit a write signal from the pre-amplifier 112 (FIG. 2) to the writer 164 (see FIG. 3) of the magnetic head and additional traces 185 and 186 disposed between the read traces 182a and 182b and the write traces 184a and 184b. The additional traces 185 and 186 may include a ground trace 185 connected to the ground layer 171 that is at a ground potential and a flying on demand (FOD) trace 186 to transmit a driving signal to an FOD element (not illustrated) to finely adjust the flying height of the head slider 160 (see FIG. 3). The FOD element may include a heating element provided in the head slider 160 or in the suspension 155 (see FIG. 3).

The cover layer 175 includes a read cover layer 176 to seal the read traces 182a and 182b, a write cover layer 177 to seal the write traces 184a and 184b, a ground cover layer 178 to seal the ground trace 185 and an FOD cover layer 179 to seal the FOD trace 186. The read cover layer 176, the write cover layer 177, the ground cover layer 178 and the FOD cover layer 179 are not connected to each other, and are separated from each other. The cover layers 176 through 179 that are separated from each other may be formed as follows. A polyimide film is precisely cut, and then the polyimide film is attached to the base layer 173 so that cut pieces of the polyimide film, corresponding to respective cover layers 176 through 179 are spaced apart from each other. In another method, barrier ribs (not illustrated) are formed on appropriate portions between the traces 182b and 185, between 185 and 186, and between 186 and 184a, polyimide paste is coated on the base layer 173 and the traces 182a, 182b, 184a, 184b, 185 and 186, and then the barrier ribs are removed. In another method, a mask to prevent vapor-deposition is disposed between 182b and 185, between 185 and 186, and between 186 and 184a, and then polyimide is vapor-deposited on the base layer 173 and traces 182a, 182b, 184a, 184b, 185 and 186.

A cross-talk influence XTₙₑₐᵣ represents a value whereby driving signals flowing through the ground trace 185 or the FOD trace 186 instead of through the read traces 182a and 182b affect an input node of the pre-amplifier 112 via the read traces 182a and 182b, thereby deteriorating a data reproducing performance. In this regard, the cross-talk influence XTₙₑₐᵣ is given by equation 1. When a read signal flows through the read traces 182a and 182b, a write signal does not flow through the write traces 184a and 184b. Thus, the cross-talk between the read and write signals is not considered.

A cross-talk influence XT_{far} represents a value whereby signals flowing through the traces 184a, 184b, 185 and 186 instead of through the read traces 182a and 182b affect the magnetic head 162 (see FIG. 3), in particular, the reader 166, thereby damaging or deteriorating the reader 166. In this regard, the cross-talk influence XT_{far} is given by equation 2.

$$\begin{matrix}XTnear = \frac{1}{4} ( \frac{{C}_{m L}}{{C}_{L}} + \frac{{L}_{m L}}{{L}_{L}} ) & ( 1 ) \\ XTfar = \frac{{L}_{en}}{{t}_{R}} \frac{1}{2 v} ( \frac{{C}_{m L}}{{C}_{L}} - \frac{{L}_{m L}}{{L}_{L}} ) & ( 2 )\end{matrix}$$

where C_{mL} is a mutual capacitance per unit length between an aggressor causing damage and a victim damaged by the aggressor due to cross-talk, L_{mL} is a mutual inductance per unit length between the aggressor and the victim, C_{L} is self capacitance per unit length, and L_{L} is self inductance per unit length. In addition, Lₑₙ is a distance by which the aggressor and the victim proceed in parallel, t_{R} is a rising time of a signal, and v is a speed of a signal.

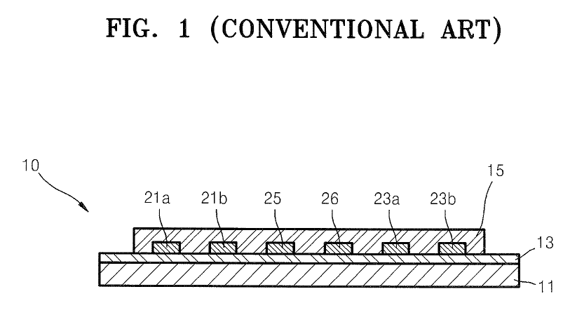

In the suspension interconnect 170, since the read cover layer 176 of the read traces 182a and 182b, which is a victim, is separated from the write, ground and FOD cover layers 177, 178 and 179 of the write, ground and FOD traces 184a, 184b, 185 and 186, C_{mL} is reduced while in terms of L_{mL}/L_{L} and other parameters, the present general inventive concept may be similar to the conventional art. Thus, the suspension interconnect 170 can prevent noise in the read signal due to cross-talk, damage or deterioration of the reader 166 (see FIG. 3) compared with the conventional suspension interconnect 10 (see FIG. 1).

FIG. 5 is a cross-sectional view illustrating a suspension interconnect 200 according to another embodiment of the present general inventive concept. The suspension interconnect 200 can replace the suspension interconnect 170 of FIG. 4 so as to be used in the HGA 150 illustrated in FIG. 3.

Referring to FIG. 5, the suspension interconnect 200 includes a ground layer 201, a base layer 203 formed on the ground layer 201, traces 212a, 212b, 214a, 214b, 215, 216 and 217 formed on the base layer 203, a cover layer 205 which is formed on the base layer and the traces 212a, 212b, 214a, 214b, 215, 216 and 217 and is to seal the traces 212a, 212b, 214a, 214b, 215, 216 and 217, like in the case of the suspension interconnect 170 of FIG. 4. The ground layer 201, the base layer 203, the traces 212a, 212b, 214a, 214b, 215, 216 and 217 and the cover layer 205 are formed of the same material and are formed using the same method as the suspension interconnect 170 of FIG. 4, and thus their description will not be given here.

Like in the case of the suspension interconnect 170 of FIG. 4, the traces 212a, 212b, 214a, 214b, 215, 216 and 217 include a pair of read traces 212a and 212b, a pair of write traces 214a and 214b, and a ground trace 215 and an FOD trace 216 as additional traces. The additional traces may further include a dual servo actuator (DSA) trace 217 to transmit a driving signal to a DSA element to finely adjust track following of the head slider 160 (see FIG. 3). For example, the DSA element may include a micro actuator (not illustrated) interposed between the head slider 160 and an end of the suspension 155 supporting the head slider 160.

Like in the case of the suspension interconnect 170 of FIG. 4, the cover layer 205 includes a read cover layer 206, a write cover layer 207, a ground cover layer 208 and an FOD cover layer 209, which are separated from each other. In addition, the cover layer 205 further includes a DSA cover layer 210 to seal the DSA trace 217 and is separated from the read, write, ground and FOD cover layers 206 through 209. In the suspension interconnect 200, the read cover layer 206 of the read traces 212a and 212b is separated from the write, ground, FOD and DSA cover layers 207 through 210 of the write, read, ground, FOD and DSA traces 214a, 214b, 215, 216 and 217. Thus, the suspension interconnect 200 can prevent noise in a read signal due to cross-talk, damage or deterioration of the reader 166 (see FIG. 3) compared with the conventional suspension interconnect 10 (see FIG. 1).

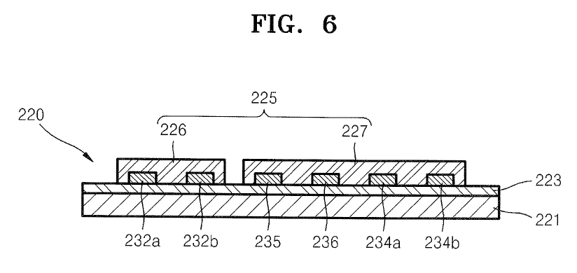

FIG. 6 is a cross-sectional view illustrating a suspension interconnect 220 according to another embodiment of the present general inventive concept. The suspension interconnect 220 can replace the suspension interconnect 170 of FIG. 4 so as to be used in the HGA 150 illustrated in FIG. 3.

Referring to FIG. 6, the suspension interconnect 220 includes a ground layer 221, a base layer 223 formed on the ground layer 221, traces 232a, 232b, 234a, 234b, 235 and 236 formed on the base layer 223, a cover layer 225 which is formed on the base layer 223 and the traces 232a, 232b, 234a, 234b, 235 and 236 and is to seal the traces 232a, 232b, 234a, 234b, 235 and 236, like in the case of the suspension interconnect 170 of FIG. 4. The ground layer 221, the base layer 223, the traces 232a, 232b, 234a, 234b, 235 and 236 and the cover layer 225 are formed of the same material and are formed using the same method as the suspension interconnect 170 of FIG. 4, and thus their description will not be given here.

Like in the case of the suspension interconnect 170 of FIG. 4, the traces 232a, 232b, 234a, 234b, 235 and 236 include a pair of read traces 232a and 232b, a pair of write traces 234a and 234b, and a ground trace 235 and an FOD trace 236 as additional traces.

The cover layer 225 includes a read cover layer 226 sealing the read traces 232a and 232b and a write cover layer 227 extending so as to seal not only the write traces 234a and 234b but also the ground and FOD traces 235 and 236. The read cover layer 226 and the write cover layer 227 are separated from each other. In the suspension interconnect 220, the read cover layer 226 sealing the read traces 232a and 232b is separated from the write cover layer 227 sealing the write, ground and FOD traces 234a, 234b, 235 and 236. Thus, the suspension interconnect 220 can prevent noise in a read signal due to cross-talk, damage or deterioration of the reader 166 (see FIG. 3) compared with the conventional suspension interconnect 10 (see FIG. 1). In addition, the cover layer 225 is separated into only two parts instead of into three or more, and thus the suspension interconnect 220 can be more easily manufactured compared with the suspension interconnects 170 and 200 of FIGS. 4 and 5.

According to the above various embodiments, since a cover layer to seal a read trace is separated from cover layers to seal other traces in a suspension interconnect, the suspension interconnect can prevent noise of a read signal due to cross-talk, damage or deterioration of a magnetic head, compared with the conventional suspension interconnect.

While the present general inventive concept has been particularly illustrated and described with reference to exemplary embodiments thereof, it will be understood by one of ordinary skill in the art that various changes in form and details may be made therein without departing from the spirit and scope of the present general inventive concept as defined by the following claims.

What is claimed is:

1. A suspension interconnect usable with a hard disk drive (HDD), the suspension interconnect comprising:
a ground layer;
a base layer formed of a dielectric material and disposed on the ground layer;
a pair of read traces and a pair of write traces which are formed of a conductive material and disposed on the base layer extend so as not to short each other; and
a cover layer which is formed of a dielectric material, is disposed on the base layer and the traces to seal the traces,
wherein the cover layer comprises a read cover layer to seal the read traces, and a write cover layer which is separated from the read cover layer and to seal the write traces.

2. The suspension interconnect of claim 1, further comprising:
at least one additional trace formed of a conductive material between the read traces and the write traces on the base layer,
wherein the cover layer further comprises at least one additional cover layer which is separated for the read cover layer and the write cover layer, respectively, and seals the at least one additional trace.

3. The suspension interconnect of claim 2, wherein the additional trace comprises:
at least one selected from a ground trace that is at a ground potential, a flying on demand (FOD) trace to transmit a driving signal to an element to finely adjust a flying height of a head slider of a hard disk drive (HDD), and a dual servo actuator (DSA) trace to transmit a driving signal to an element to finely adjust track-following of the head slider.

4. The suspension interconnect of claim 1, further comprising:
at least one additional trace formed of a conductive material between the read traces and the write traces on the base layer,
wherein the write cover layer extends to seal the write traces and the at least one additional trace.

5. The suspension interconnect of claim 4, wherein the at least one additional trace comprises at least one selected from a ground trace that is at a ground potential, a flying on demand (FOD) trace to transmit a driving signal to an element to finely adjust a flying height of a head slider of a hard disk drive (HDD), and a dual servo actuator (DSA) trace to transmit a driving signal to an element to finely adjust track-following of the head slider.

6. The suspension interconnect of claim 1, wherein the ground layer is formed of a metal.

7. The suspension interconnect of claim 1, wherein the dielectric material used to form the base layer and the cover layer is polyimide.

8. A head gimbal assembly (HGA) including a suspension, a head slider attached to and supported by the suspension and a suspension interconnect connected to the head slider in order to transmit a signal, the suspension interconnect comprising:
a ground layer;
a base layer formed of a dielectric material and disposed on the ground layer;
a pair of read traces and a pair of write traces which are formed of a conductive material on the base layer to extend so as not to short each other; and
a cover layer which is formed of a dielectric material, is disposed on the base layer and the traces to seal the traces,
wherein the cover layer comprises a read cover layer to seal the read traces, and a write cover layer which is separated from the read cover layer and is to seal the write traces.

9. The HGA of claim 8, wherein the suspension interconnect further comprises:
at least one additional trace formed of a conductive material between the read traces and the write traces on the base layer,
wherein the cover layer further comprises at least one additional cover layer which is separated from the read cover layer and the write cover layer, respectively, and is to seal the at least one additional trace.

10. The HGA of claim 9, wherein the additional trace comprises:
at least one selected from a ground trace that is at a ground potential, a flying on demand (FOD) trace to transmit a driving signal to an element to finely adjust a flying height of a head slider of a hard disk drive (HDD), and a dual servo actuator (DSA) trace to transmit a driving signal to an element to finely adjust track following of the head slider.

11. The HGA of claim 8, wherein the suspension interconnect further comprises:
at least one additional trace formed of a conductive material between the read traces and the write traces on the base layer,
wherein the write cover layer extends to seal the write traces and the at least one additional trace.

12. The HGA of claim 11, wherein the at least one additional trace comprises:
at least one selected from a ground trace that is at a ground potential, a flying on demand (FOD) trace to transmit a driving signal to an element to finely adjust a flying height of a head slider of a hard disk drive (HDD), and a dual servo actuator (DSA) trace to transmit a driving signal to an element to finely adjust track following of the head slider.

13. The HGA of claim 8, wherein the ground layer is formed of a metal.

14. The HGA of claim 8, wherein the dielectric material used to form the base layer and the cover layer is polyimide.

15. A suspension interconnect usable with a hard disk drive (HDD), the suspension interconnect comprising:
a base layer formed of a dielectric material, and having a first set of read traces disposed thereon and a second set of other traces formed of a conductive material; and
a read cover layer formed of a dielectric material, and to seal the read traces from the second set of other traces.

16. The suspension interconnect of claim 15, further comprising:
one or more cover layers to seal the second set of other traces,
wherein the one or more cover layers is not the read cover layer.

17. The suspension interconnect of claim 15, wherein the second set of other traces comprise:
at least write traces which are formed of a conductive material and disposed on the base layer.

18. The suspension interconnect of claim 17, wherein the second set of other traces further comprises:
at least one of a ground trace that is at a ground potential, a flying on demand (FOD) trace to transmit a driving signal to an element to adjust a flying height of a head slider of the HDD, and a dual servo actuator (DSA) trace to transmit a driving signal to an element to adjust track following of the head slider.

19. An interconnect apparatus, the suspension interconnect comprising:
a base layer;
a first trace formed on a first portion of the base layer;
a second trace formed on a second portion of the base layer;
a first cover layer formed on the first trace; and
a second cover layer formed on the second trace and spaced apart from the first cover layer by a distance with respect to the base layer.

20. The interconnect apparatus of claim 19, wherein the first cover layer and the second cover layer are isolated from each other.

21. The interconnect apparatus of claim 19, wherein:
the first cover layer has a first thickness;
the second cover layer has a second thickness; and
the distance is longer than a sum of the first thickness and the second thickness.

22. The interconnect apparatus of claim 19, wherein the first trace comprises a plurality of sub-traces, and the first cover layer is formed on the plurality of sub-traces.

23. The interconnect apparatus of claim 19, wherein the first cover layer and the second cover layer are physically separated from each other.
